(19) United States
(12) Patent Application Publication
(10) Pub. No.: US 2005/0025187 A1
(43) Pub. Date: Feb. 3, 2005

(54) Signal processing of transmission packets

(76) Inventors: Yun Xin Li, Ryde (AU); Henry William Peter Beadle, Chipping Norton (AU); John Grosspietsch, Libertyville, IL (US); Xiaojing Huang, Waverton (AU); Son Minh Nguyen, St. Kingsford (AU)

Correspondence Address: DANIEL K. NICHOLS;Motorola, Inc., Law Department, 1303 E. ALGONQUIN ROAD, SCHAUMBURG, IL, 60196, US

(21) Appl. No.: 10/631,257

(22) Filed: Jul. 31, 2003

(51) Int. Cl. H04J 3/00

(52) U.S. Cl. 370/476; 370/345

(57) ABSTRACT

A communications unit (2) and method (50) for providing a transmission packet (30), the transmission packet (30) comprising a data independent field (32) and a payload field (33). The unit (2) and method (50) performs processing digital data (54) to provide a modulated digital payload. The method then performs a step (55) of obtaining pre-defined modulated transmission protocol bits stored in a memory. Then a combining step (56) provides for combining the modulated digital payload and the predefined modulated transmission protocol bits to provide the transmission packet (30), wherein the modulated digital payload is in the payload field (33) and the modulated transmission protocol bits are in the data independent field (32).

### FIELD OF THE INVENTION

This invention relates to signal processing of packets typically used by transceivers. The invention is particularly useful for signal processing of packets comprising a payload field and data independent field.

### BACKGROUND ART OF THE INVENTION

Communications devices have many applications including telephony, two-way radio communications, internet data transfer and satellite to base station communications. In recent years there has been an ever increasing demand for communications applications, especially in the field of wireless voice and data communications, as is apparent from the rapid increased number of cellular telephone and wireless local area network users.

To meet the ever-growing demand for communications applications, protocols using transmission packets comprising a data independent field and payload field have become a commonly accepted method for transmitting both voice and data. Typically, both the data independent field and payload field are modulated by one of the well-known modulation techniques before the transmission packet is transmitted over a radio frequency channel or otherwise. These transmission packets are generally formed by a digital signal processor performing modulating, filtering and shaping both a payload of data and data independent bits. The payload of data is information (text, voice, images etc) comprising the data dependent field and the data independent bits form the data independent field comprising a preamble sequence and header information. Accordingly, the modulating, filtering and shaping requires high speed complex digital processing of large bit volumes. However, such digital processing requires relatively high power consumption when effected on battery powered portable communication devices. This is contrary to today's trend of compact multi-function portable communication devices, with limited battery power resources. There is therefore a need to reduce battery consumption requirements associated with packetization and modulation of voice and data.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is a method for providing a transmission packet, the transmission packet comprising a data independent field and a payload field, the method comprising processing digital data to provide a modulated digital payload. The method then performs a step of obtaining a pre-defined modulated transmission protocol bits stored in a memory. Then a combining step provides for combining the modulated digital payload and the predefined modulated transmission protocol bits to provide the transmission packet, wherein the modulated digital payload is in the payload field and the modulated transmission protocol bits are in the data independent field.

Preferably, the method includes the further step of Digital to Analogue Converting the transmission packet.

Preferably, the processing further includes filtering the digital data.

Suitably, the processing further includes shaping the digital data.

The modulated transmission protocol bits may suitably include a bit sequence representative of a digitally modulated version of the synchronization sequence. The modulated transmission protocol bits may suitably include a bit sequence representative of a digitally shaped version of the synchronization sequence. The modulated transmission protocol bits may suitably include a bit sequence representative of a digitally filtered version of the synchronization sequence.

The modulated transmission protocol bits may suitably include a bit sequence representative of a digitally modulated version of packet length information identifying the number of bits in the payload field. The modulated transmission protocol bits may suitably include a bit sequence representative of a digitally shaped version of the packet length information. The modulated transmission protocol bits may suitably include a bit sequence representative of a digitally filtered version of the packet length information.

The modulated transmission protocol bits may suitably include a bit sequence representative of a digitally modulated version of data rate information. The modulated transmission protocol bits may suitably include a bit sequence representative of a digitally shaped version of the data rate information. The modulated transmission protocol bits may suitably include a bit sequence representative of a digitally filtered version of the data rate information.

Preferably, the obtaining includes selecting the pre-defined modulated transmission protocol bits from a group of pre-defined modulated transmission protocol bits stored in the memory.

Suitably, the obtaining includes selecting the pre-defined modulated transmission protocol bits from a group of pre-defined preamble bits and group of header bits, the preamble bits including a bit sequence representative of the synchronization sequence.

Suitably, the method has the further step of transmitting the transmission packet.

According to another aspect of the invention there is provided a communications unit method for providing a transmission packet, the transmission packet comprising a data independent field and a payload field, the communications unit comprising a processor and a memory storing pre-defined modulated transmission protocol bits, the memory being operatively coupled to the processor. The communications unit has a Digital to Analogue Converter coupled to the processor, wherein in use, the processor receives and processes a plurality of bits to provide, to the Digital to Analogue Converter, a modulated digital payload combined with the modulated transmission protocol bits to provide the transmission packet, and wherein the modulated digital payload is in the payload field and the modulated transmission protocol bits are in the data independent field.

The modulated transmission protocol bits may suitably include a bit sequence representative of a digitally modulated version of the synchronization sequence. The modulated transmission protocol bits may suitably include a bit sequence representative of a digitally shaped version of the synchronization sequence. The modulated transmission protocol bits may suitably include a bit sequence representative of a digitally filtered version of the synchronization sequence.

The modulated transmission protocol bits may suitably include a bit sequence representative of a digitally modulated version of packet length information identifying the number of bits in the payload filed. The modulated transmission protocol bits may suitably include a bit sequence representative of a digitally shaped version of the packet length information. The modulated transmission protocol bits may suitably include a bit sequence representative of a digitally filtered version of the packet length information.

The modulated transmission protocol bits may suitably include a bit sequence representative of a digitally modulated version of data rate information. The modulated transmission protocol bits may suitably include a bit sequence representative of a digitally shaped version of the data rate information. The modulated transmission protocol bits may suitably include a bit sequence representative of a digitally filtered version of the data rate information.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram of an electronic communications device in accordance with the present invention;

FIG. 2 is a block diagram of a communications unit comprising part of electronic communications device of FIG. 1;

FIG. 3 illustrates a transmission packet;

FIG. 4 illustrates pre-defined modulated transmission protocol bits stored in a Read Only Memory of the transceiver of FIG. 2; and

FIG. 5 is a flow diagram of a method for providing a transmission packet in accordance with the present invention that may be effected by the electronic communications device of FIG. 1.

### DETAILED DESCRIPTION OF THE PREFERRED EMBODIMENT OF THE INVENTION

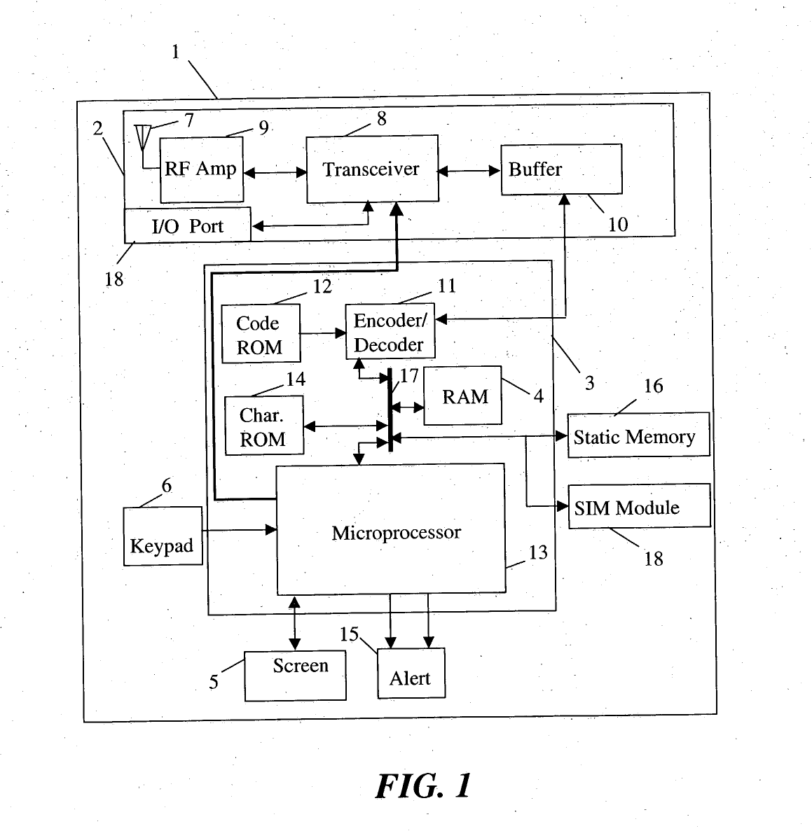

In the drawings, like numerals on different Figs are used to indicate like elements throughout. With reference to FIG. 1, there is illustrated an electronic communications device in the form of a radio telephone 1 comprising a communications unit 2 coupled to be in communication with a processor 3. An input interface in the form of a screen 5 and a keypad 6 are also coupled to be in communication with the processor 3.

The processor 3 includes an encoder/decoder 11 with an associated Read Only Memory (ROM) 12 storing data for encoding and decoding voice or other signals that may be transmitted or received by the radio telephone 1. The processor 3 also includes a micro-processor 13 coupled, by a common data and address bus 17, to an encoder/decoder 11 and an associated character Read Only Memory (ROM) 14, a Random Access Memory (RAM) 4, static programmable memory 16 and a removable SIM module 18. The static programmable memory 16 and SIM module 18 each can store, amongst other things, selected incoming text messages and a telephone book database.

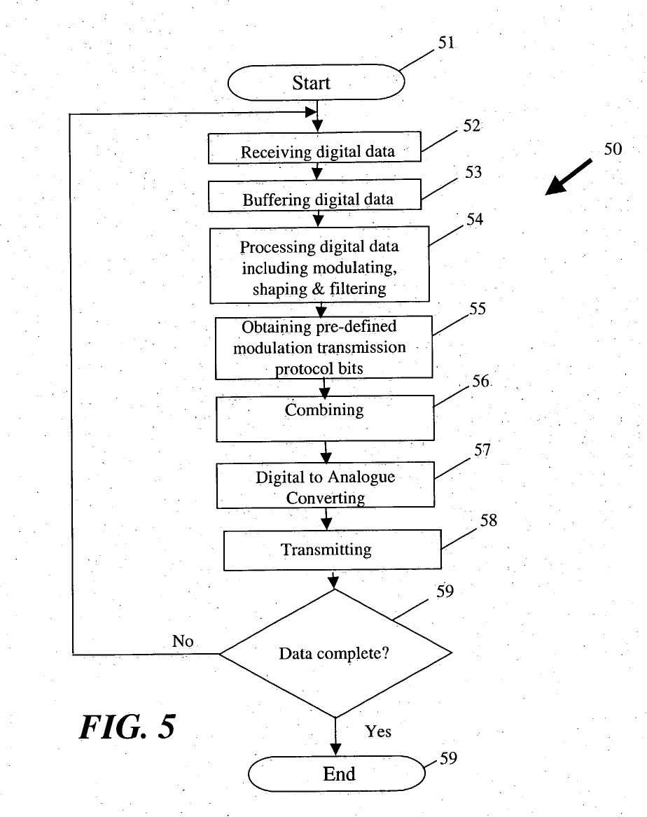

The micro-processor 13 has ports for coupling to the keypad 6, the screen 5 and an alert module 15 that typically contains a speaker, vibrator motor and associated drivers. The character Read Only Memory 14 stores code for decoding or encoding text messages that may be received by the communications unit 2, input at the keypad 6. In this embodiment the character Read Only Memory 14 also stores operating code (OC) for micro-processor 13 and code for performing a method as described below with reference to FIG. 5.

The communications unit 2 is a combined receiver and transmitter having a common antenna 7. The communications unit 2 has a transceiver 8 coupled to antenna 7 via a radio frequency amplifier 9. The transceiver 8 is also coupled to a buffer 10 that couples the communications unit 2 to the processor 3. Optionally, the communications unit 2 has an input/output port 18 for wired coupling, via a network, allowing communications with other suitable devices that are coupled to the network. The input/output port 18 is directly coupled to the transceiver 8 by a two way link as illustrated. Also, the transceiver 8 is coupled to the microprocessor 13 thereby allowing the transceiver 8 to receive instructions IS used for digital signal processing of voice or data required to be transmitted.

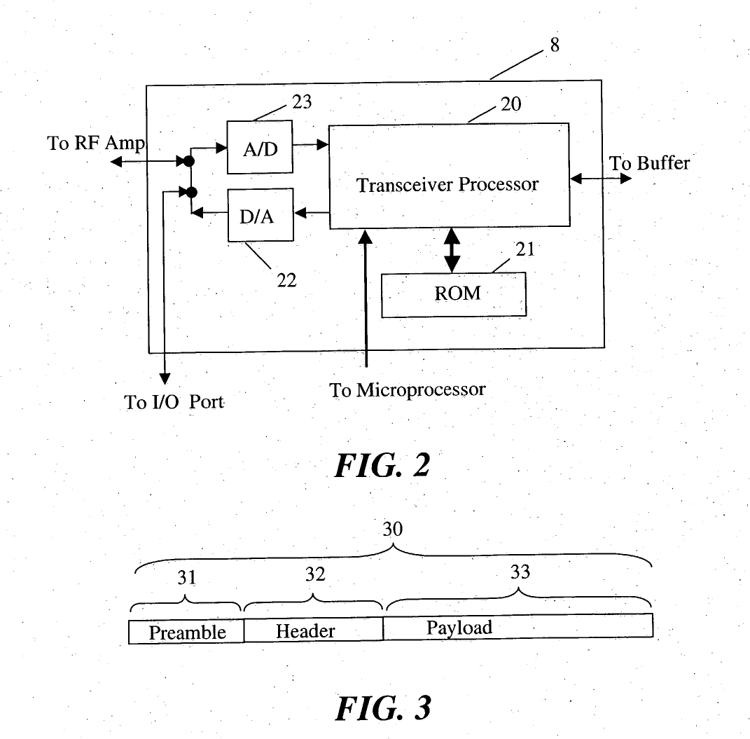

Referring to FIG. 2, there is illustrated a block diagram of the transceiver 8 comprising a dedicated digital signal processor in the form of a transceiver processor 20. The transceiver processor 20 is a programmable processor that is operatively coupled to a Read Only Memory 21 by a common data and address bus, The transceiver processor 20 also has a data output operatively coupled to an input of a Digital to Analogue Converter 22 and a data input operatively coupled to an output of a Analogue to Digital Converter 23. The transceiver processor 20 also has a control port operatively coupled to the microprocessor 13 and a data port coupled to the buffer 10. Further, an output of the Digital to Analogue Converter 22 and an input of the Analogue to Digital Converter 23 are operatively coupled to both the input/output port 18 and the radio frequency amplifier 9.

Referring to FIG. 3 there is illustrated a transmission packet 30 comprising a preamble field 31, a header field 32 and a payload field 33. The preamble field 31 and header field 32, when combined, form a data independent field. The payload field 33 is a processed version bits stored and supplied to the transceiver processor 20 from the buffer 10.

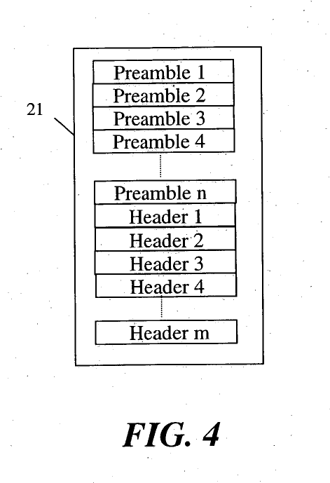

In FIG. 4 there is illustrated a group of pre-defined modulated transmission protocol bits stored in the Read Only Memory 21. The modulated transmission protocol bits comprise a plurality of preamble fields 31, from preamble field bits 1 to preamble field bits n, and a plurality of header fields 32, from header field 1 to header field m. Each of the preamble fields 31 comprises a synchronization sequence and each of the header fields 32 comprises packet length information identifying the number of bits in the payload field 33, transmission data rate information, modulation data indicative of a type of modulation used to provide the modulated digital payload in field 33 and the address of the device or radio telephone 1 that may be associated with the SIM module 18. Accordingly, as will be apparent to a person skilled in the art, the pre-defined modulated transmission protocol bits, of preamble fields 31 and header fields 32, are digitally modulated, shaped and filtered versions of the synchronization sequence, packet length information, data rate information, modulation type used to the modulated digital payload, the address of the device, and type of payload (voice, text, image etc).

Referring to FIG. 5, there is illustrated a method 51 for providing the transmission packet 30 comprising the data independent field, formed from the preamble field 31 and header field 32, and the payload field 33. The method 30 after a start step 51 can be invoked, for example, by a user sending a send image command via the keypad 6 to the microprocessor 13. The method then performs step of receiving 52 digital data DD representing the image at the communications unit 2. The digital data DD typically being provided by the RAM 4 along bus 17 and through encoder/decoder 11. The buffer 10 then performs buffering of the digital data DD at a buffering step 53. The transceiver processor 20 then performs a processing step 54 for processing the digital data DD to provide a Modulated Digital Payload MDP. During the processing step 54 the digital data DD is digitally modulated, filtered and shaped by the transceiver processor 20 using known techniques. These modulation techniques include amplitude modulation, phase modulation, frequency modulation, and any combination of such modulations known to a person skilled in the art. The filtering and shaping techniques include any processing of modulated digital data DD to control their spectral occupancy and/or time-domain pulse shape to make them suitable for transmission over wireless or wired communications link.

The method 50 then performs a step of obtaining 55. In the step of obtaining 55, the transceiver processor 20 performs selectively obtaining the pre-defined modulated transmission protocol bits from the preamble field bits 1 to preamble field bits n and, the header field 1 to header field m stored in the Read Only Memory 21. The selection of the preamble field bits 1 to preamble field bits n and, the header field 1 to header field m is dependent upon the instructions IS provided by the microprocessor 13. The instructions IS are determined based on, amongst others, quality of signal requirements, type of payload (voice, text, image etc), data rate requirements and modulation type. The transceiver processor 20 then performs a step of combining 56 the modulated digital payload MDP and the selected pre-defined modulated transmission protocol bits to provide the transmission packet 30. As a result, the modulated digital payload MDP is in the payload field 33 and the pre-defined modulated transmission protocol bits are in the data independent field comprising the preamble field 31 and header field 32.

The method 50 then performs digital to analogue converting at step 57 effected by the Digital to Analogue Converter 22. The analogue version of the transmission packet 30 is then transmitted, at a transmitting step 58, by either the radio frequency amplifier 9 and antenna 7 combination or the input/output port 18 depending on whether wireless or wired transmission of the packet 30 is required. The method then returns to step 52 if more data has is being received and terminates if all data has been processed by the transceiver processor 20.

Advantageously, the present invention provides for reduced battery consumption requirements associated with packetization and modulation of voice and data. This is apparent because the invention alleviates the need to continuously modulate, filter and shape known, non-variable data independent preamble and header protocol bits.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

1. A method for providing a transmission packet, the transmission packet comp rising a data independent field and a payload field, the method comprising:
processing digital data to provide a modulated digital payload;
obtaining pre-defined modulated transmission protocol bits stored in a memory; and
combining the modulated digital payload and the predefined modulated transmission protocol bits to provide the transmission packet, wherein the modulated digital payload is in the payload field and the modulated transmission protocol bits are in the data independent field.

2. A method, according to claim 1, including the further step of Digital to Analogue Converting the transmission packet.

3. A method, according to claim 1, wherein the processing further includes filtering the digital data.

4. A method, according to claim 3, wherein the processing further includes shaping the digital data.

5. A method, according to claim 1, wherein the modulated transmission protocol bits include a bit sequence representative of a digitally modulated version of the synchronization sequence.

6. A method, according to claim 1, wherein the modulated transmission protocol bits include a bit sequence representative of a digitally shaped version of the synchronization sequence.

7. A method, according to claim 1, wherein the modulated transmission protocol bits include a bit sequence representative of a digitally filtered version of the synchronization sequence.

8. A method, according to claim 1, wherein the modulated transmission protocol bits include a bit sequence representative of a digitally modulated version of packet length information identifying the number of bits in the payload field.

9. A method, according to claim 1, wherein the modulated transmission protocol bits include a bit sequence representative of a digitally shaped version of the packet length information.

10. A method, according to claim 1, wherein the modulated transmission protocol bits include a bit sequence representative of a digitally filtered version of the packet length information.

11. A method, according to claim 1, wherein the modulated transmission protocol bits include a bit sequence representative of a digitally modulated version of data rate information.

12. A method, according to claim 1, wherein the modulated transmission protocol bits include a bit sequence representative of a digitally shaped version of the data rate information.

13. A method, according to claim 1, wherein the modulated transmission protocol bits include a bit sequence representative of a digitally filtered version of the data rate information.

14. A method, according to claim 1, wherein the obtaining includes selecting the pre-defined modulated transmission protocol bits from a group of pre-defined modulated transmission protocol bits stored in the memory.

15. A method, according to claim 14, wherein, the obtaining includes selecting the pre-defined modulated transmission protocol bits from a group of pre-defined preamble bits and group of header bits, the preamble bits including a bit sequence representative of the synchronization sequence.

16. A method, according to claim 1, wherein the method has the further step of transmitting the transmission packet.

17. A communications unit for providing a transmission packet, the transmission packet comprising a data independent field and a payload field, the communications unit comprising:
a processor;
a memory storing pre-defined modulated transmission protocol bits, the memory being operatively coupled to the processor; and
a Digital to Analogue Converter coupled to the processor, wherein in use, the processor receives and processes a plurality of bits to provide, to the Digital to Analogue Converter, a modulated digital payload combined with the modulated transmission protocol bits to provide the transmission packet, and wherein the modulated digital payload is in the payload field and the modulated transmission protocol bits are in the data independent field.

18. A communications unit, according to claim 17, wherein the modulated transmission protocol bits include a bit sequence representative of a digitally shaped version of the synchronization sequence.

19. A communications unit, according to claim 17, wherein the modulated transmission protocol bits include a bit sequence representative of a digitally filtered version of the synchronization sequence.

20. A communications unit, according to claim 17, wherein the modulated transmission protocol bits include a bit sequence representative of a digitally modulated version of packet length information identifying the number of bits in the payload field.

21. A communications unit, according to claim 17, wherein the modulated transmission protocol bits include a bit sequence representative of a digitally shaped version of the packet length information.

22. A communications unit, according to claim 17, wherein the modulated transmission protocol bits include a bit sequence representative of a digitally filtered version of the packet length information.

23. A communications unit, according to claim 17, wherein the modulated transmission protocol bits include a bit sequence representative of a digitally modulated version of data rate information.

24. A communications unit, according to claim 17, wherein the modulated transmission protocol bits include a bit sequence representative of a digitally shaped version of the data rate information.

25. A communications unit, according to claim 17, wherein the modulated transmission protocol bits include a bit sequence representative of a digitally filtered version of the data rate information.
